(19) United States
(12) Patent Application Publication
(10) Pub. No.: US 2006/0101031 A1
(43) Pub. Date: May 11, 2006

(54) Automated dynamic routing of documents based on database storage of user relationships

(76) Inventors: Jacob Joel Faul, Carlsbad, CA (US); Brian E. Knight, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/972,075

(22) Filed: Oct. 21, 2004

(51) Int. Cl. G06F 7/00

(52) U.S. Cl. 707/100

(57) ABSTRACT

A method and system for automated dynamic routing of information based on database storage of user relationships are disclosed. In one embodiment of the invention, user relationships within an organization are centrally managed. These relationships are used as virtual destinations for the routing of business processes. When information is to be routed to a destination, the current user with the given relationship to the source user is determined, and the information is routed to the user whose identity was so determined. Processes, such as the automated routing of documents, can be defined in terms of user relationships and then left unmodified, despite changes to the user relationships within an organization, so long as the centrally managed user relationship information is kept current.

### BACKGROUND OF THE INVENTION

1. Field of the Invention

This invention relates to automated dynamic routing of documents through the use of centrally managed user relationships. More particularly, embodiments of the present invention relate to a method of using centrally managed user relationships as virtual destinations for dynamic routing of documents, as well as a system for creating, maintaining, and utilizing those relationships.

2. Description of the Related Art

Due to the fluid nature of the relationships between users within organizations, and the difficulties that frequent changes to these user relationships can present to automation of business processes, there is a need for a process of managing and controlling information which can adapt to changes in the relationship structure. Information, as used herein, can include one or more business processes. There is also a need for a process of easily creating and modifying these relationships in response to changes within the organization. There is also a need for a process of determining whether these relationships are based on already existing information within an organization, so that preexisting ways of managing relationship information can be utilized to automate business processes.

A relationship defines some connection between multiple users in an organization. These relationships can take multiple forms. A relationship can be a connection between only two users. A relationship can also be a connection between one user and a group of users. The connection between a manager and multiple employees under the supervision of that manager would be an example of such a relationship. Similarly, there can be a relationship between one user and every user in that organization. The connection between the president of an organization and the rest of that organization is an example of such a relationship. Relationships can also be defined between one group of users and another group of users. The relationship of a department within an organization to the rest of the organization is an example of this form of relationship.

### SUMMARY OF CERTAIN INVENTIVE ASPECTS

In an embodiment of the invention, there is a method of automated dynamic routing of information based on database storage of user relationships, comprising uniquely defining a plurality of relationships, maintaining the defined relationships by mapping a plurality of sources to a plurality of targets for particular relationships, designating one relationship selected from the defined relationships as a routing destination for information, resolving the designated relationship by determining a current target mapped to a corresponding source for the designated relationship, and routing the information from the source of the designated relationship to the resolved target.

In another embodiment of the invention, there is a method of automation of a business process, comprising defining a relationship between two entities, mapping a source entity to a target entity for the relationship, storing the information indicative of the mapping in a database, designating the relationship as a routing destination for a business process, resolving the relationship for the source entity, and routing the business process to the target entity.

In another embodiment of the invention, there is a method of automation of business processes, comprising mapping a source entity to a target entity for a given relationship, designating the relationship as a virtual destination for the routing of a business process, resolving the relationship for the particular source entity, and routing the business process to the target entity.

In another embodiment of the invention, there is a method of automation of business processes, comprising defining a relationship between at least two entities, mapping a source user to a target user for the relationship, designating the relationship as a routing destination for a business process, and resolving the relationship for the source user.

In another embodiment of the invention, there is a method of automation of business processes, comprising designating a relationship as a virtual destination for a business process, resolving the relationship for a given source user, and routing the business process to a target user for which the relationship with the source user was resolved.

In another embodiment of the invention, there is a method of contextual routing of information, comprising defining a relationship between a source and a target, designating the relationship as a routing destination for the information, resolving the relationship for the source, and routing the information from the source to the target.

In another embodiment of the invention, there is a system for automation of business processes, comprising a centrally managed database containing relationship information, wherein target users are mapped to source users for a plurality of given relationships; a resolver in data communication with the database, configured to identify a target user based on a particular source user and the mapped information; a process engine in data communication with the resolver, configured to route processes based on designated relationships; and a network computer, in communication with the process engine via a network, configured to designate relationships as destinations for routing processes.

In another embodiment of the invention, there is a system for automation of business processes, comprising a database containing relationship information, including a mapping of a source user to a target user for a given relationship; a resolver in data communication with the database, configured to determine the target user mapped to the source user for the given relationship; and a process engine, configured to route a business process to the target user based on the given relationship used as a virtual destination.

In another embodiment of the invention, there is a system for automation of business processes, comprising a database containing user relationship information; a process engine, configured to route business processes to targets based on designated relationships; and a resolver in data communication with the database and the process engine, configured to determine a given target user, based on a source user and a particular relationship.

In yet another embodiment of the invention, there is a method of automation of business processes, comprising defining a first relationship; for a plurality of source entities, mapping each source entity to a target entity for the relationship; designating the relationship as a virtual destination for a business process; and resolving the relationship for a given source entity.

### BRIEF DESCRIPTION OF THE DRAWINGS

FIG. 1 is a block diagram showing one embodiment of a configuration for documents based on user relationships in an automated business process system.

FIG. 2 is a flowchart showing one embodiment of a process for resolving user relationships maintained by the system shown in FIG. 1.

FIG. 3 is an exemplary screen display for maintaining user relationships via the system shown in FIG. 1.

FIG. 4 is an exemplary screen display of a dialog box for adding or editing a user relationship.

FIGS. 5A and 5B are exemplary screen displays of a dialog box for customization of a user relationship.

FIG. 6 is an exemplary screen display for maintaining a given user's relationships.

FIG. 7 is an exemplary screen display for modifying a user relationship connect agent, used to query an external system for relationship information.

FIG. 8 is an exemplary screen display for modifying a user relationship connect agent, used to query an external system for relationship information.

FIG. 9A is a diagram showing a pair of organizational charts and a table representing one embodiment of a one-to-many relationship, in which multiple users have the same relationship to a particular user.

FIG. 9B is a diagram showing a pair of organizational charts and a table representing one embodiment of a one-to-one relationship, in which no users have the same relationship to a particular user.

FIG. 9C is a flow diagram showing one embodiment of a business process in which the target of form routing is dependent on the originator's relationships.

### DETAILED DESCRIPTION OF CERTAIN INVENTIVE EMBODIMENTS

The following description presents certain specific embodiments of the present invention. However, the present invention may be embodied in a multitude of different ways as defined and covered by the claims. In this description, reference is made to the drawings wherein like parts are designated with like numerals throughout.

A relationship can be defined in terms of mapping a target to a source, where the target has the given relationship to the source. For example, if A is B's manager, for a relationship defined as “manager,” B would be the source user, and A would be the target user. In one embodiment, resolving a relationship is the determining of the particular target user who is mapped to a particular source user for the given relationship. Thus, if the relationship “manager” was resolved for B, the result would be the target user, A.

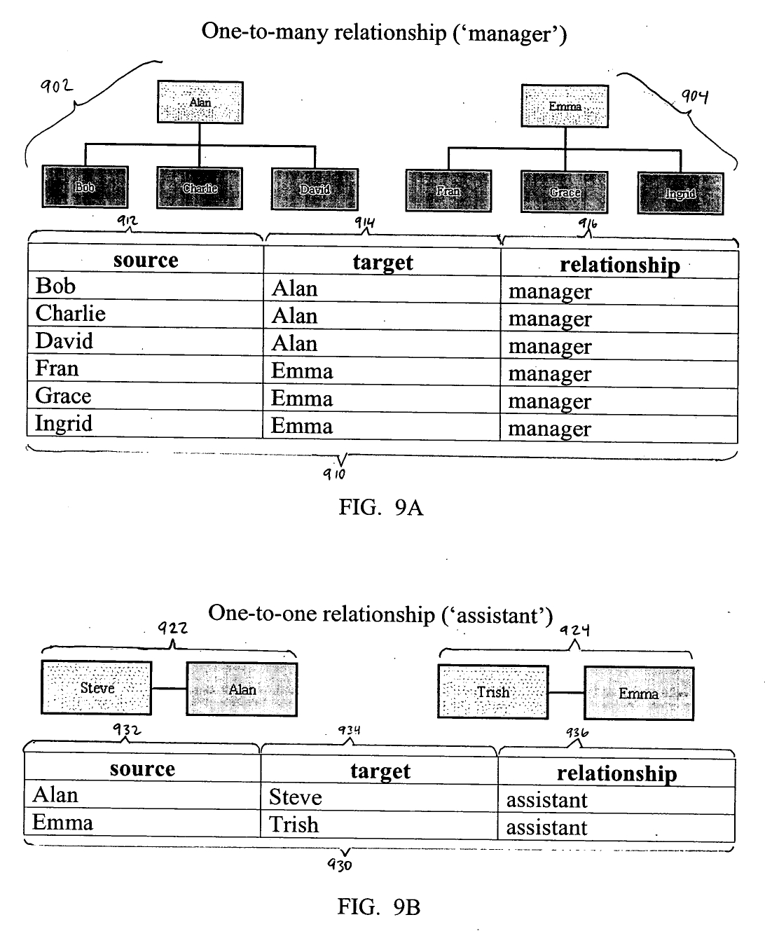

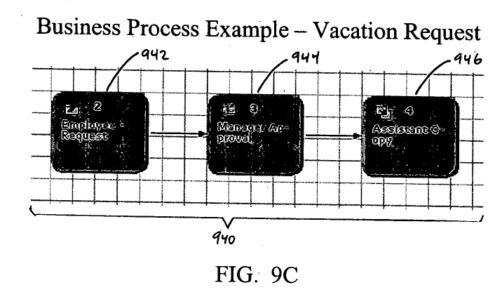

Two examples of mapping of source users to target users are discussed with respect to FIGS. 9A and 9B. FIG. 9A depicts an embodiment of a one-to-many relationship. In this case, the relationship is “manager”. Organizational charts 902 and 904 depict the hierarchy of this relationship for two distinct groups of people. In chart 902, Alan is the manager of Bob, Charlie and David. In chart 904, Emma is the manager of Fran, Grace and Ingrid. Table 910 presents this information in tabular form. Column 912 contains source users. Column 914 contains the target user mapped to the source user for the given relationship listed in column 916. If the relationship “manager” is resolved for Charlie, the resulting target user will be Alan.

FIG. 9B depicts an embodiment of a one-to one relationship. In this case, the relationship is “assistant”. Organizational charts 922 and 924 depict these relationships for two distinct groups of people. Table 930 depicts the information in charts 922 and 924 in tabular form. If the relationship “assistant” is resolved for Alan, the resulting target user will be Steve. In both FIGS. 9A and 9B, the relationships are defined on a global level, so that two distinct groups of people can be mapped for the same relationship, with no overlap. In a large organization, the users mapped for a relationship such as “assistant” could consist of many distinct groups with no overlap.

In one embodiment, a system for managing and applying relationships between users in an organization is designed to permit the assignment of relationships to either individual users or groups of users. If a group of users exists such that the same target users will be mapped to the group for multiple relationships, it may be more efficient to define the users as being part of a particular group, and then map those target users for those relationships to the group itself. For those relationships for which different target users will be mapped to members of the group, relationships can be mapped on an individual level, or through the use of other appropriate groups, as further embodiments advantageously allow one user to be a member of multiple groups. In alternate embodiments of the present invention, a group can be mapped as a target user to a particular source user. In FIG. 9A, it can be seen that the same target user was mapped to multiple source users for the “manager” relationship. It may be advantageous in certain situations to define a group consisting of source users who share a target user, such as Bob, Charlie and David. If a group were created consisting of those three users, Alan could be mapped to that group as a target user. Resolution of the relationship for any one of the source users would still result in Alan as the target user.

In one embodiment, a system for managing and utilizing relationships in order to automate business processes is designed to permit the creation of relationships not only between two persons within a relationship, but also between, for example, a person and an entity, such as a work queue. While this description refers to “users” and “user relationships,” it will be understood that a user relationship can be set up to establish a connection with an entity such as a work queue or a group of users. For example, a workflow process could be created that would route information, such as forms to be filled out, to a particular computer terminal, or a particular work queue, so that any person within the organization who accessed that terminal or queue would be able to access and modify that information as required. A relationship could also be defined in terms of prior actions taken by users.

In one embodiment, a system for managing and applying relationships between users in an organization is provided such that relationships can be defined on a global level, rather than simply between individual users. A relationship such as manager can be defined for an organization such that for two users with different managers, the relationship will represent a connection with a different user in the organization. However, the manager relationship as a whole can be centrally managed, for reasons of efficiency and uniformity across the organization. In such an embodiment, each relationship can be assigned a unique relationship ID.

The initial configuration of relationships can be done in multiple ways. In one embodiment, an interface is provided for manual creation and configuration of relationships. In further embodiments, an extended Relationship Connect Agent architecture is provided. This architecture allows an organization to create a custom Connect Agent plug-in, which can be used to retrieve relationship data from existing customer data. In further embodiments, a Connect Agent is provided which can be used to retrieve relationship data from an existing database, such as an SQL database.

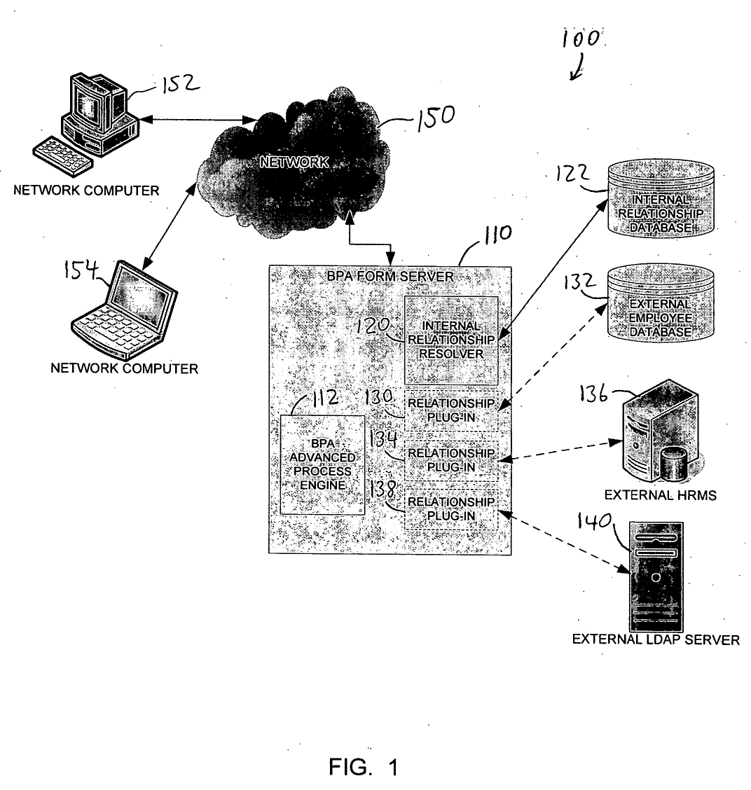

A system employing one embodiment is discussed with respect to FIG. 1. The system comprises a Business Process Automation form server 110. In various further embodiments, the BPA form server can be either a distinct server or an engine or module located or installed on a computer already within the organization. The BPA form server 110 comprises a BPA advanced process engine 112, and an internal relationship resolver 120. In various further embodiments, the engine 112 and resolver 120 can be either a system or a module, and in further embodiments need not be distinct from one another. The resolver 120 is in data communication with an internal relationship database 122, either directly or through a network. The database 122 in various embodiments may be located either on the BPA form server 110 or elsewhere, such as on another server. As used in this application, internal refers to information managed by the system itself, while external refers to information managed by some other system.

Depending on the configuration of the system, an organization may choose to maintain an external database containing employee information and use that external database to maintain the mapping of relationships between users. This external employee database may be in addition to, or in place of, storing employee information in the internal relationship database 122, and multiple external databases may be used simultaneously The external database may take the form of an external employee database 132. In various embodiments of the invention, the external employee database 132 may be managed either on the same server as the BPA form server or elsewhere. 110. Alternately, the external database may take the form of an external Human Resources Management System 136, or an external lightweight directory access protocol (LDAP) server 140. The BPA form server may communicate with the external database through optional relationship plug-ins 130, 134, and 138, which can be either created in advance or created by the user in order to interface with the external database. Since the relationship plug-ins can be user created, the system can interface with any external system, such as a database, containing employee information.

The user interfaces with the BPA form server 110 by means of a network computer 152 or 154, which is in communication with the BPA form server through a network 150. The network can be the Internet, or any other suitable network, such as an organization's internal network. Use of the Internet as the network 150 advantageously permits the user to access the BPA Form Server from virtually anywhere and at anytime.

When these connections between users are defined in terms of relationships, rather than in terms of the actual names of the users or groups of users involved, management of these relationships makes possible automation and maintenance of routing and workflow processes even as the structure of the organization changes. Business processes, such as interactive routing processes and structured workflow processes, can be set up such that the recipients are determined based on user relationships, enabling automated, dynamic routing. A relationship can be used as a virtual destination for a task in a business process. Assignment of tasks can also be made interactively by the user in a business process.

For example, a manager can set up a routing process whose recipients are those users who are under the supervision of that manager. To do this, the manager uses the relationship between the users and their manager as a virtual destination for the routing process. As structure of the organization changes and users leave the supervision of that manager and new users take their place, the routing event itself needs no modification so long as the user relationship information is maintained. This is particularly advantageous when large amounts of users are involved in a routing process, or when large amounts of routing processes need to be maintained, because modification of the user relationships is simpler than such large scale modification of the routing processes.

Another exemplary business process is described with respect to FIG. 9C, making reference to FIGS. 9A and 9B, and the information contained in the tables therein. The flow diagram in FIG. 9C depicts a business process 940 in which an employee makes a request for a vacation. This process 940 begins at a stage 942, wherein the employee fills out a request for vacation. The process 940 then moves to a stage 944, wherein the form is sent to the employee's manager for review. Finally, after approval by the manager, the process 940 moves to a stage 946, wherein a copy of the form is sent to the manager's assistant. This business process can be advantageously created at a global level, in terms of user relationships. For two employees with different managers, however, the vacation request form will be routed to different users within the organization.

If Bob fills out a vacation request form using the above-defined business process, the destination of the form upon completion will be determined by resolving the relationship “manager” for Bob. Thus, the form will be routed to Alan. The destination of the form once Alan approves the form will be determined by resolving the relationship “assistant” for Alan. Thus, a copy of the form will be sent to Steve. Similarly, if Fran filled out a vacation request form using the above-defined business process, the form would first be routed to Emma upon completion, and a copy would be sent to Trish upon approval.

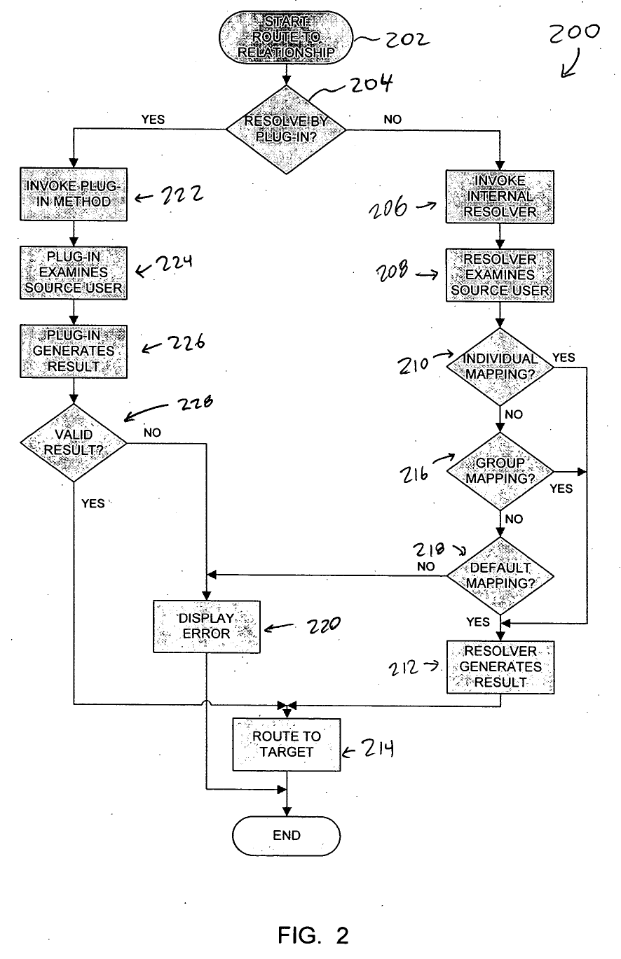

In order to utilize a user relationship as a target for some business process, the relationship must be resolved for a particular user, referred to as the source user. The user to which the relationship will resolve for that particular source user is referred to as the target user. With respect to FIG. 2, a process 200 through which a given relationship is resolved for a given source user in one embodiment is discussed.

The process 200 begins at a state 202, where a given relationship and a given source user are known.. The process 200 moves to a state 204, where it is determined whether the relationship is to be resolved based on the internal relationship database 122 (FIG. 1), or via a plug-in based on external data, such as an external employee database 132, an external HRMS 136, or an external LDAP server 140.

If the process 200 determines that it will be resolved based on the internal database, it moves to state 206, where the internal relationship resolver 122 is invoked, and then to state 208 where the resolver examines the mapping for the source user. The process 200 moves to a state 210 where it determines whether the source user is individually mapped to a particular target user for the given relationship. If so, that target user will be used, and the process 200 will move to a state 212 where that target user is returned as the routing target. The process 200 will then move to a state 214, where the business process is routed to the identified target user.

If the source user is not individually mapped to a target user, the process 200 then moves to a state 216 where it determines whether the source user is a member of a group which is mapped to a target user for the given relationship. If the source user is a member of such a group, the process 200 moves to the state 212 and that target user is used.

When relationships are defined in terms of groups, an additional level of complexity arises, as a user can be both an individual user, and a member of one or more groups. Conflicts may arise when a user has one value for a relationship as an individual, and another as a member of a group, or has different values for a relationship as a member of multiple groups. In such a case, priority rules will be used to determine the resolution of that relationship.

In one embodiment, these rules are configured such that the relationship value that a user has as an individual takes precedence over the value that the user has as part of a group. Such a configuration can be seen in the flowchart depicted in FIG. 2. When a user has no individual value for that relationship, a group value is used.

However, if the process 200 determines at state 216 that more than one group to which the user belongs has a value for that relationship, the resolution of that relationship can be determined by means of priority rules. In various embodiments, these rules can determine the target user to be used in multiple ways, such as the assignment of a priority value to those groups, determination on the basis of the order in which the user joined those groups, or a random determination of a particular group whose value will be used.

If the source user is not mapped as part of a group to a target user, the system then moves to a state 218, where it determines whether there is a default target user mapped for a given relationship. If such a default target user is mapped to the given relationship, the system moves to the state 212, and that target user is used. If no default target user is mapped to the given relationship, process 200 moves to state 220 where an error message may be displayed, if appropriate. In various embodiments, once the process 200 reaches state 220, the business process may be left unrouted, or routed back to the source user, or routed to a default user or queue.

If the process 200 determines at state 204 that the relationship will be resolved based on external data, the process 200 then moves to a state 222 where the particular plug-in to be used to determine the relationship is determined and invoked. The process 200 then moves to a state 224 where the plug-in is provided with the source user and the relationship ID. The process 200 then moves to a state 226 where the plug-in returns a result based on the source user and relationship ID. The process 200 then moves to a state 228 where it determines whether the target user returned by the plug-in is a valid result. If the result is valid, it moves to state 214, and the returned target user is used to route the business process. If the result is invalid, the process 200 moves to state 220, where an error message may be displayed.

Administrator Configuration of Relationships

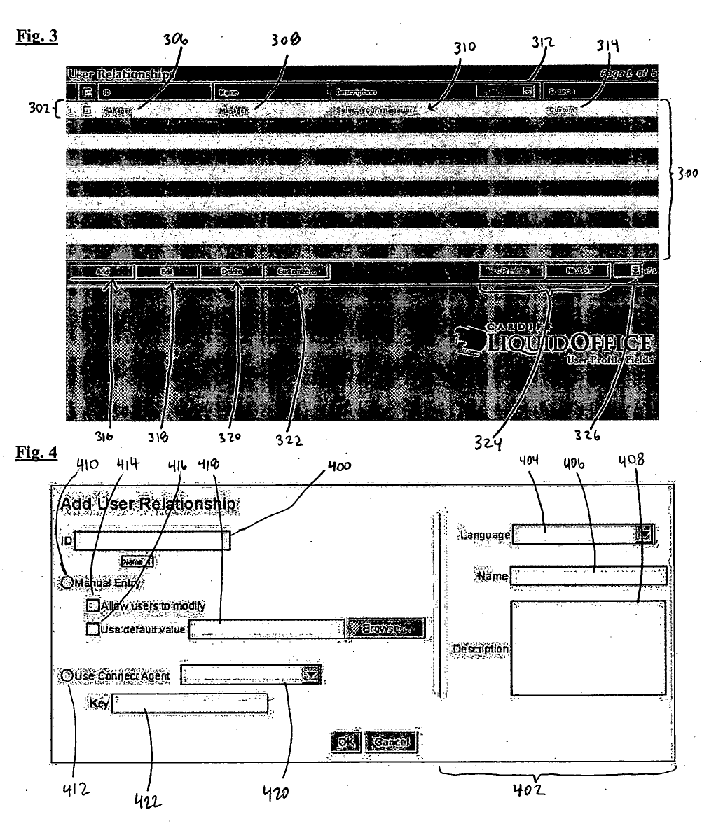

In various embodiments, user relationship data can be created and maintained through interaction with the software, as discussed with respect to FIG. 3. FIG. 3 represents a User Relationships page, which is used to list the defined relationships, as well as to permit authorized persons to add new relationships, edit existing relationships, or delete relationships. The authorized person may be the administrator, or a User Relationship Manager, a person who has the authorization to manage relationships. While it is not necessary to restrict access to the User Relationships page, it is advantageous to provide an administrator with the ability to restrict access to this page, if they desire to do so.

In one embodiment, the user relationships are displayed in a list, with each line of the list being a user relationship entry 302. The list 300 contains fields such as a non-localized relationship ID 306, a localized name 308, and a localized description 310. In one embodiment, the localized name and description can be edited and viewed in a particular language. In a further embodiment, the language in which the localized name and description are to be edited and viewed can be selected from a drop-down list 312 on the User Relationships page. The list of user relationships also contains a “Source” field 314, which indicates the manner in which the target value of the user relationship is mapped to the source user, for instance, by manual mapping, or from an external database via a Connect Agent.

An “Add” button 316 is provided on the User Relationships page, which displays the interface for adding relationships. An “Edit” button 318 displays the interface for editing relationships. In one embodiment, the Edit button is only enabled when a single user relationship is selected from the list above. The “Delete” button 320 is used to delete one or more relationships from the list above. In one embodiment, the delete button deletes selected relationships from the list above. The “Customize” button 322 allows modification of a specific user relationship. In one embodiment, the button is only enabled if a single user relationship is selected from the list, and the source of that user relationship was manual entry. In various embodiments, processes are provided for navigating through large numbers of user relationships, such as “<Previous” and “Next>” buttons 324, drop down page list 326, or scroll bars.

In one embodiment, adding and editing of user relationships is done via the interface shown in FIG. 4. If the Add button 316 from FIG. 3 was clicked, a unique, non-localized, relationship ID will then be entered into the ID field 400, either by the user at the prompting of the software, or automatically. If the Edit button 318 from FIG. 3 was clicked, the ID field 400 will be read-only in some embodiments. The field 402 on the right side of FIG. 4 permits selection of a language via a drop-down box 404, and localization of the name and description via name field 406 and description field 408. In this embodiment, the default language selection in drop-down box 404 is the value of drop-down list 312 at the time the user pressed the Add or Edit button. In this embodiment, the interface shown in FIG. 4 enables the user to add a user relationship either manually or via a Connect Agent by clicking one of the radio buttons 410, 412.

Check box 414 allows the administrator to control whether the users can modify their own individual values for this relationship. For example, if the user relationship is “manager,” users may be permitted to select their manager in order to map the proper target user to themselves. Modification by the source user of the target user mapped to that source user may be advantageous when there is no existing external database from which the user mapping can be determined. Check box 416 permits the administrator to set a default value whenever a relationship value is not set for an individual user. If box 416 is checked, the value of field 418 will be the default value for this relationship. In a further embodiment, when a default value is set, the user may be unable to clear field 418 such that no target user is mapped to the user. Such a configuration may be advantageous as it will prevent errors resulting from unresolvable relationships.

If radio button 412 is selected, the administrator can make use of a Connect Agent in order to gather relationship data. Drop-down list 420 can be used to select a particular Connect Agent, and key field 422 can be used to provide a key name to the Connect Agent in order to map the relationship ID to an alternate ID used by an external system. By default, the key field 422 will be filled with the relationship ID 400, but the administrator can enter any key name in field 422, enabling mapping of external organizational data already in place. In further embodiments of the invention, a single relationship ID may be associated with multiple key names. This advantageously permits association of a single relationship with multiple equivalent relationships in the external system which have different alternate IDs. In further embodiments of the present invention, a single relationship ID can be associated, via multiple key names and one or more Connect Agents, with multiple equivalent relationships located on a plurality of external systems. This advantageously permits unification of equivalent relationships across a plurality of external systems. This advantageously permits maintenance of relationship data to be done largely on whatever external system the organization already has in place.

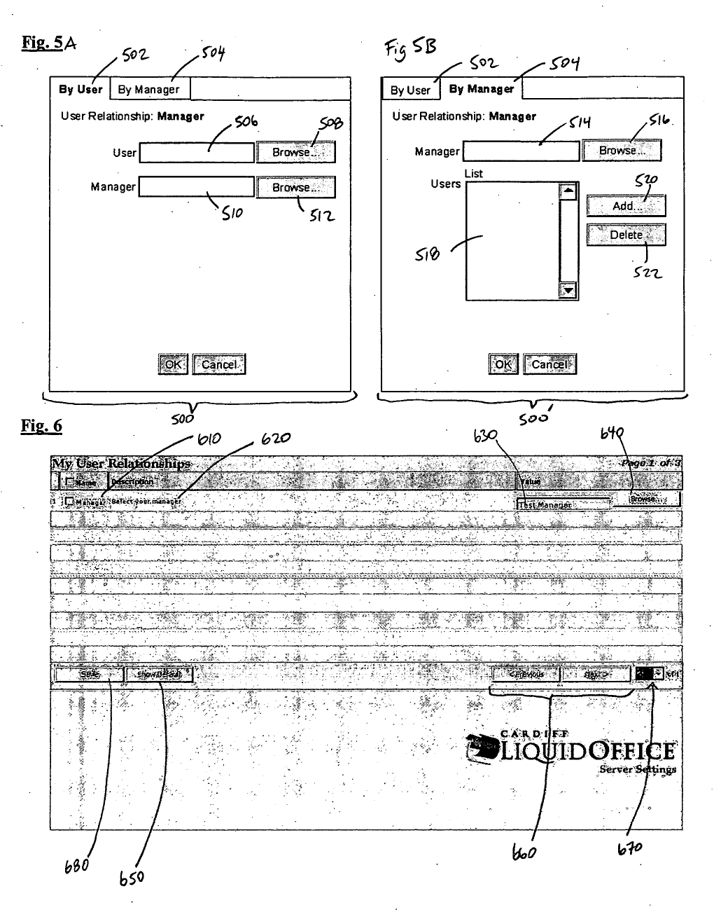

In one embodiment, customization of the user relationships is done by an authorized person in the tabbed dialog boxes 500 and 500′ shown in FIG. 5A and 5B, respectively. In this embodiment, the tabbed dialog box 500 is brought up by selecting a user relationship on the User Relationship page of FIG. 3, and then clicking on the “Customize” button 322. Clicking on the appropriate tabs 502 and 504 toggles between the states of the dialog boxes 500 and 500′ shown in FIGS. 5A and 5B, respectively. In the state shown in FIG. 5A, searching can be done by the source user or group. In the state shown in FIG. 5B, searching can be done by the target user or work queue. In this example, the source user is referred to as “User” and the target user is referred to as “Manager”.

In the state shown in FIG. 5A, the administrator can search by source user. That is to say, the administrator can select a User and select a Manager to associate with that User. In various embodiments, that selection could be done by entering the name of the source user directly into the source field 506 or by selecting from a list of source users brought up by clicking the “Browse” button 508. In one embodiment, when the administrator has selected a source user, the target field 510 is automatically filled in by resolving the current target user mapped to that source user for that particular relationship. In various embodiments, the associated target user can be selected either by entering the name of the target into the target field 510 or by selecting from a list of target users brought up by clicking the “Browse” button 512. In alternative embodiments, a drop-down list could replace one or both of fields 506 and 510.

In the state shown in FIG. 5B, the administrator can search by filling in target field 514 with the target user or work queue, either by entering it directly or by using “Browse” button 516 in the manner discussed previously with respect to the other “Browse” buttons. In one embodiment, the source list 518 is automatically populated with those source users already associated with the target in field 514 for the specified relationship. Users can be added to the list 518 by use of the “Add” button 520, which can function in a manner similar to button 516. Administrators can remove selected users from list 518 by using the “Delete” button 522.

User Configuration of Relationships

In one embodiment, users are able to configure at least some portion of their user relationships. In a further embodiment of this invention, the user can access a user relationship page such as the one depicted in FIG. 6. Information may be displayed to the user in localized format according to the users preferred language or cultural settings. For example, if the user's preferred language is selected to be English, the relationship name 610 can be prefixed with “My,” and similar modifications could be made to the relationship description 620. Appropriate translations of similar localizing details can be provided for various languages and cultures. In various embodiments, selection of the preferred language can be done either by means of a drop-down list or by using settings which the user could define outside of the user relationship page. Alternately, language and culture settings could be defined by an administrator.

In one embodiment, the target relationship value, such as the name of a user or a work queue, will be displayed in a read-only format in field 630. A new target value can be selected from a list of possible target values brought up by clicking the “Browse” button 640. The default value can be restored by clicking the “Show Default” button 650. In alternate embodiments, the target value could be manually entered into the field 630. In further embodiments, processes are provided for navigating through large numbers of user relationships, such as “<Previous” and “Next>” buttons 660, drop down page list 670, or scroll bars. In certain embodiments, changes to user relationships are saved as they take place. In other embodiments, a “Save” button 680 could be used to save modifications of user relationships.

Using Relationships

User relationships can be selected as routing targets in multiple ways. Individual users may select a user relationship as a routing target, or predefined routing targets can be established such that the actual routing is dependent on the originator's relationship.

A user wishing to route something to another user with whom the user has a relationship can establish that relationship as a routing target. In this case, the target user is determined by resolving the relationship for the current user. In one embodiment, this can be done by means of a routing page, where the routing target can be selected. In a further embodiment, this routing page displays relationships along with users and work queues. This advantageously allows users to utilize a relationship as a routing target when it is efficient to do so, or to select a particular user or work queue as a target directly. Thus, a user need not set up a relationship when routing something directly to another user would be more efficient, such as when the routing process is unlikely to be repeated, or the appropriate target user is unlikely to change.

In further embodiments, the information presented on the routing page is advantageously localized such that it is clear that the target of the routing process will be determined by resolving the relationship for the current user. For instance, the relationship names can be prefixed by the word “My”, or a localized equivalent.

Alternately, routing targets can be selected such that the routing process is independent of the user creating the routing process, and dependent on the user relationships of the user who is the originator of the routed information. In this case, the target user is determined by resolving the relationship for the originator. In an embodiment of this invention, a routing setup page is provided, which permits the user to set up automated business processes based on relationships which will be resolved to other users.

In further embodiments, the information presented on the routing setup page is advantageously localized such that it is clear that the target of the routing process is determined by resolving the relationship for the originator. For example, the relationship names can be prefixed by the word “Originator's”, or a localized equivalent.

In one embodiment, the business process automation can comprise the routing of information to particular users or work queues, such as forms to be filled out, or task assignments. In such cases, a user relationship can be employed as a virtual destination for the information. In further embodiments, the information being routed may require approval by another user at some point. In such cases, a user relationship can be used to designate an approver.

A user relationship can be selected as a first approver for the information to be routed. In such a case, when the necessary work has been completed on a piece of information by a user, the user need not select a destination by a routing page. If the relationship can be resolved for the originating user, the form can be routed to the target user without need for configuration on the part of the originating user. If the relationship is unable to be resolved for the originating user, a routing page may be provided to the originator, so that a new user relationship or target user can be selected, and the information can be routed to the new destination.

A user relationship may also be selected as a final approver for the information. In such a case, final approval can only be given by the target user obtained by resolving the specified relationship for the originator. In further embodiments, if the relationship cannot be resolved for the originator, the form can be treated as though no final approver was defined. Alternately, other methods of handling an unresolvable relationship can be employed, such as previously determining a default user relationship who can give final approval.

User Relationship Connect Agent Setup

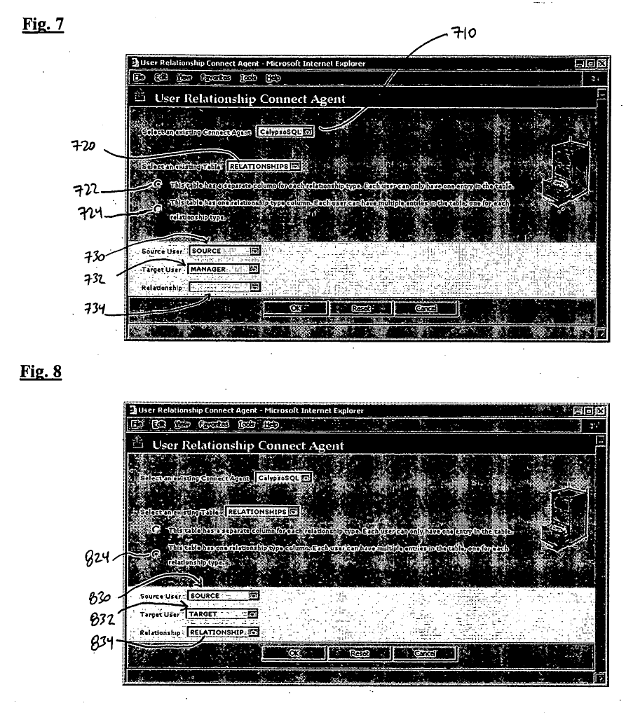

In an embodiment of the present invention, user relationship connect agents are created and configured to resolve user relationships from external systems, such as databases. A user relationship connect agent in a particular embodiment is discussed with respect to FIGS. 7 and 8. A user relationship connect agent (URCA) utilizes a connect agent, such as an SQL connect agent, to obtain from an external system, such as a database, the target user mapped to a particular source user for a given relationship. A connect agent such as an SQL connect agent is distinct from a URCA. While a URCA may utilize a connect agent such as an SQL connect agent in order to perform such tasks as data lookup or data export from forms, a URCA will be configured to utilize that connect agent in order to query for user relationship targets. In the present embodiment, a user relationship connect agent is configured by the setup page such as depicted in FIG. 7 and similarly for FIG. 8.

The setup page shown in FIG. 7 contains a drop-down list 710 of connect agents. In the page depicted, the connect agent selected is an SQL connect agent, but the connect agent selected could be any connect agent provided to or created by the user. Once the connect agent is selected, the drop-down list 720 is populated with a list of potential tables from which information can be retrieved, namely the target user mapped to a particular source user for that relationship. A table is selected from the drop-down list 720. One of the radio buttons 722, 724 is selected, indicating the manner in which information is stored in the table. Radio button 722 indicates that the table has a separate column for each relationship type, and that each user can only have one entry in the table. Radio button 724 indicates that there is one relationship type column, and that each user can have multiple entries in the table, as much as one for each relationship type.

If button 722 is selected, the drop-down lists 730, 732, and 734 are populated with the names of columns of information from the selected table in the following manner, as seen in FIG. 7. The user can use drop-down list 730 to select the “Source” column, which contains the list of unique user IDs. The user can use drop-down list 732 to select the “Target User” column, which contains user names whose relationship to the source user is represented by the name of the column. Drop-down list 734, which would be used to select the “Relationship” column is disabled, as the relationship is determined by the “Target User” column selected via drop-down list 732. In the present embodiment, the relationship name will be the name of the selected target user column, although in further embodiments, alternate column names could be used.

If button 724 (824 in FIG. 8) is selected, the drop-down lists 730, 732, and 734 are populated with the columns of information from the selected table in the following manner, as seen in FIG. 8. The “Source” column selected via drop-down list 830 contains the list of user IDs. The “Relationship” column selected via drop-down list 834 contains the list of relationship IDs. The “Target User” column selected via drop-down list 832 contains the list of users whose relationship to the source user is represented by the contents of the relationship column.

The two types of tables indicated by buttons 722 and 724/824 are exemplary, and it is to be understood that alternate database configurations could be used to store relationship mapping information. In such embodiments, the name, function, and number of drop down lists such as 730, 732, and 734 will vary.

Conclusion

Specific blocks, sections, devices, functions, processes and modules may have been set forth. However, a skilled technologist will realize that there are many ways to partition the system, and that there are many parts, components, processes, modules or functions that may be substituted for those listed above.

While the above detailed description has shown, described and pointed out the fundamental novel features of the invention as applied to various embodiments, it will be understood that various omissions and substitutions and changes in the form and details of the system illustrated may be made by those skilled in the art, without departing from the intent of the invention. The foregoing description details certain embodiments of the invention. It will be appreciated, however, that no matter how detailed the foregoing appears, the invention may be embodied in other specific forms without departing from its spirit or essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

Appendices follow which demonstrate the use of the Connect Agents and a software development kit, which are provided with an embodiment of the present invention.

Appendix A includes server script methods in the CSUser server script object that can be used to resolve a relationship for a specific user and to determine the type of user object.

Appendix B describes a IUserRelationship Agent interface implemented by Relationship Connect Agents.

Appendix C describes a CSUserRelationship class in the software development kit utilized to build Relationship Connect Agents.

Appendix D describes a CSUser class in the software development kit utilized to build Relationship Connect Agents.

Appendix A. Additions to CSUser server script object

CSUser getRelationshipTarget(String relationshipID)

Description:
Gets the target for the user relationship with the given relationship ID. The source of the user relationship is the user described by the object upon which this method is invoked.

Arguments:
String relationshipID
Specifies the relationship ID.

Returns:
CSUser
Returns a CSUser object identifying the target of the specified user relationship or null if the user relationship is not defined..

String getType( )

Description:
Gets the type of this user object. The type is “User” for a regular user or “Queue” for a work queue.

Returns:
String
Returns the type of this user object as a String.
   Appendix B. IUserRelationshipAgent interface for SDK

public CSUser getRelationshipTarget(CSUserRelationship userRelObj)

Description:
This method is called to resolve a relationship target.

Arguments:
CSUserRelationship userRelObj
Information describing a user relationship in a CSUserRelationship object.

Returns:
CSUser
Returns a CSUser object identifying the target of the specified user relationship or null if the user relationship is not defined.
   Appendix C. CSUserRelationship class for SDK

public CSConnectAgentSetup getConnectAgentSetup( )

Description:
Get Connect Agent setup information. This information was saved when the administrator last set up the connect agent using the Connect Agent Setup JSP.

Return:
CSConnectAgentSetup
Returns Connect Agent setupinformation in a CSConnectAgentSetup object.

public String getID( )

Description:
Get the relationship ID.

Return:
String
Returns the relationship ID.

public CSLocale getLocale( )

Description:
Get locale information. This provides access to the localization preferences for the current user and the default server localization setting.

Return:
CSLocale
Returns locale information in a CSLocale object.

public String getKey( )

Description:
Get the relationship key. This key may be used instead of the relationship ID as an alternate mapping ID for retrieving existing data from an external system. An Administrator who is defining user relationships may modify the key for an individual relationship. By default, the key is the same as the relationship ID.

Return:
String
Returns the relationship key.

public CSServer getServer( )

Description:
Get server information.

Return:
CSServer
Returns server information in a CSServer object.

public CSUser getSource( )

Description:
Get the source user for which the user relationship is to be resolved.

Return:
CSUser
Returns source user information in a CSUser object.
   Appendix D. CSUser class for SDK

public CSUser(String id, String type, boolean bUserID)

Description:
Class constructor.

Arguments:
String id
The user ID, login ID, or work queue ID.
String type
The user type: “User” for a regular user or “Queue” for a work queue.
boolean bUserID
Set to true if the id parameter is a user ID, false if the id parameter is a login ID. This parameter is ignored if the type is “Queue”.

public String getUserID( )

Description:
Gets the user ID of the user. In LDAP installations, this is the unique full path user ID such as “cn=jsmith, cn=recipients, ou=engineering”.

Returns:
String
Returns the user ID as a String.

public String getLoginID( )

Description:
Gets the login ID of the user. The login ID may be unique on the server depending on the server settings. The login ID is the ID the user types in to log in to LiquidOffice.

Returns:
String
Returns the login ID of the user.

public String getEmailAddress( )

Description:
Gets the user's e-mail address.

Returns:
String
Returns the user's e-mail address as a String.

public String getFirstName( )

Description:
Gets the user's first name.

Returns:
String
Returns the user's first name as a String.

public String getMiddleName( )

Description:
Gets the user's middle name.

Returns:
String
Returns the user's middle name as a String.

public String getLastName( )

Description:
Gets the user's last name.

Returns:
String
Returns the user's last name as a String.

public String getDisplayName( )

Description:
Gets the display name of the user. The display name is typically first, middle and last name together separated by a space though it can be different.

Returns:
String
Returns the display name of the user.

public String getLanguageCode( )

Description:
Gets the language code of the language the user is currently using. Language code is determined based on the user preference set on the server. Language codes are those specified in ISO 639.

Returns:
String
Returns a two-character language code.

public String getCountryCode( )

Description:
Gets the country code of the country the user is currently using. Country code is determined based on the user preference set on the server. Country codes are those specified in ISO 3166.

Returns:
String
Returns a two-character country code.

public CSUser getRelationshipTarget(String relationshipID)
Description:
Gets the target for the user relationship with the given relationship ID. The source of the user relationship is the user described by the object upon which this method is invoked.

Arguments:
String relationshipID
Specifies the relationship ID.

Returns:
CSUser
Returns a CSUser object identifying the target of the specified user relationship or null if the user relationship is not defined..

public String getType( )

Description:
Gets the type of this user object. The type is “User” for a regular user or “Queue” for a work queue.

Returns:
String

Returns the type of this user object as a String.

What is claimed is:

1. A method of automated dynamic routing of information based on database storage of user relationships, comprising:
uniquely defining a plurality of relationships;
maintaining the defined relationships by mapping a plurality of sources to a plurality of targets for particular relationships;
designating one relationship selected from the defined relationships as a routing destination for information;
resolving the designated relationship by determining a current target mapped to a corresponding source for the designated relationship; and
routing the information from the source of the designated relationship to the resolved target.

2. The method of claim 1, wherein relationship mapping is maintained via an external system.

3. The method of claim 2, wherein the external system is a database..

4. The method of claim 3, wherein the designated relationship is resolved based on information in the external database via a relationship plug-in.

5. The method of claim 1, additionally comprising determining whether the given relationship is resolved via an internal relationship resolver or via a relationship plug-in in communication with an external system.

6. The method of claim 1, wherein either the target or the source is a group of entities.

7. The method of claim 1, wherein either the target or the source is a work queue.

8. The method of claim 1, wherein either the target or the source is an entity and the relationship is defined based on the prior actions of a user.

9. The method of claim 8, wherein the target or the source is a task or a form such that the relationship is defined based on a user previously associated with that task or form.

10. The method of claim 1, such that the user relationships are maintained by a subset of the users, wherein the subset has permission to modify information indicative of the mapping for the plurality of defined relationships.

11. The method of claim 1, wherein the maintaining of the defined relationships comprises changing an entity associated with a given relationship.

12. A method of automation of a business process, comprising:
defining a relationship between two entities;
mapping a source entity to a target entity for the relationship;
storing the information indicative of the mapping in a database;
designating the relationship as a routing destination for a business process;
resolving the relationship for the source entity; and
routing the business process to the target entity.

13. The method of claim 12, wherein the database is an external database.

14. The method of claim 12, wherein a portion of the information indicative of the mapping is stored in an internal database, and another portion of the information indicative of the mapping is stored in an external database.

15. The method of claim 14, additionally comprising determining whether the relationship is to be resolved based on information indicative of the mapping stored in an internal database or in an external database.

16. The method of claim 15, wherein a relationship to be resolved based on information indicative of the mapping stored in an external database is resolved via a relationship plug-in.

17. The method of claim 12, wherein a business process comprises the routing of information.

18. The method of claim 13, wherein a business process comprises the routing of a document.

19. A method of automation of business processes, comprising:
mapping a source entity to a target entity for a given relationship;
designating the relationship as a virtual destination for the routing of a business process;
resolving the relationship for the particular source entity; and
routing the business process to the target entity.

20. The method of claim 19, additionally comprising storing the information indicative of the mapping in a database.

21. The method of claim 20, wherein either the source entity or the target entity is based on the relationship being defined in response to prior assigned tasks or actions of a user.

22. The method of claim 19, wherein either the source entity or the target entity is a task or form, wherein the relationship is defined based on a user's previous association with that task or form.

23. The method of claim 20, wherein the relationship information indicative of the mapping is dynamically maintained in response to events.

24. The method of claim 23, wherein the events comprise the routing of the form or the assignment of the task to another user.

25. A method of automation of business processes, comprising:
defining a relationship between at least two entities;
mapping a source user to a target user for the relationship;
designating the relationship as a routing destination for a business process; and
resolving the relationship for the source user.

26. A method of automation of business processes, comprising:
designating a relationship as a virtual destination for a business process;
resolving the relationship for a given source user; and
routing the business process to a target user for which the relationship with the source user was resolved.

27. A method of contextual routing of information, comprising:
defining a relationship between a source and a target;
designating the relationship as a routing destination for the information;
resolving the relationship for the source; and
routing the information from the source to the target.

28. A system for automation of business processes, comprising:
a centrally managed database containing relationship information, wherein target users are mapped to source users for a plurality of given relationships;
a resolver in data communication with the database, configured to identify a target user based on a particular source user and the mapped information;
a process engine in data communication with the resolver, configured to route processes based on designated relationships; and
a network computer, in communication with the process engine via a network, configured to designate relationships as destinations for routing processes.

29. The system of claim 28, wherein the process engine maintains a list of previously routed business processes.

30. The system of claim 29, wherein the process engine dynamically maintains mappings for relationships defined in terms of previously routed business processes.

31. The system of claim 28, wherein the resolver comprises an internal resolver configured to determine a target user based on information indicative of the mapping in an internal database.

32. The system of claim 31, wherein the information in the internal database is managed by the system.

33. The system of claim 32, wherein the resolver further comprises one or more relationship plug-ins configured to determine a target user based on information indicative of the mapping in an external system.

34. The system of claim 33, wherein the information in the external system is managed by the external system.

35. The system of claim 34, wherein the process engine is further configured to determine whether a given designated relationship is to be resolved via the internal resolver or via a particular relationship plug-in.

36. A system for automation of business processes, comprising:
a database containing relationship information, including a mapping of a source user to a target user for a given relationship;
a resolver in data communication with the database, configured to determine the target user mapped to the source user for the given relationship; and
a process engine, configured to route a business process to the target user based on the given relationship used as a virtual destination.

37. A system for automation of business processes, comprising:
a database containing user relationship information;
a process engine, configured to route business processes to targets based on designated relationships; and
a resolver in data communication with the database and the process engine, configured to determine a given target user based on a source user and a particular relationship.

38. A method of automation of business processes, comprising:
defining a first relationship;
for a plurality of source entities, mapping each source entity to a target entity for the relationship;
designating the relationship as a virtual destination for a business process; and
resolving the relationship for a given source entity.

39. The method of claim 38, wherein the mapping of source entities to target entities comprises associating the first relationship with at least a second relationship maintained via an external system in which source entities are mapped to target entities for the second relationship

40. The method of claim 38, wherein the mapping of source entities to target entities comprises associating the first relationship with a plurality of additional relationships maintained via an external system in which source entities are mapped to target entities for the plurality of additional relationships.

41. The method of claim 40, wherein at least two of the plurality of additional relationships are maintained via separate external systems.

42. The method of claim 38, wherein maintaining the information indicative of the mapping for the second relationship is done by the external system.
